(19) United States
(12) Patent Application Publication
(10) Pub. No.: US 2008/0277184 A1
(43) Pub. Date: Nov. 13, 2008

(54) FRAME FOR AN ALL-TERRAIN VEHICLE

(75) Inventor: Benoit Marleau, St-Hyacinthe (CA)

Correspondence Address: OSLER, HOSKIN & HARCOURT LLP (BRP), 2100 - 1000 DE LA GAUCHETIERE ST. WEST, MONTREAL, QC, H3B4W5, CA

(73) Assignee: BOMBARDIER RECREATIONAL PRODUCTS INC., Valcourt (CA)

(21) Appl. No.: 11/744,953

(22) Filed: May 7, 2007

(51) Int. Cl. B62D 21/00

(52) U.S. Cl. 180/312

(57) ABSTRACT

A frame for a vehicle has a first pyramidally-shaped frame portion and a second pentahedrally-shaped frame portion. The first frame portion has a first apex and a first base. The first apex is disposed vertically above the first base. The second frame portion has a first vertex and a second base. The first vertex is disposed vertically below the second base. The second frame portion is disposed vertically below the first frame portion. At least three wheel attachment portions are connected to the second pentahedrally-shaped frame portion. Each of the at least three wheel attachment portions is adapted to permit attachment of one of at least three wheels to be mounted to the frame. An all-terrain vehicle including the frame is also disclosed.

### FIELD OF THE INVENTION

The present invention relates to a frame for a vehicle. More specifically, the present invention relates to a frame for an all-terrain vehicle.

### BACKGROUND OF THE INVENTION

All-terrain vehicles (ATVs) are designed to be used over rugged terrains such as those encountered in forest and woodland environments. For this reason, the frames of ATVs are designed to resist the momentarily intense forces that can result from these riding conditions.

The frames of ATVs are also subjected to significant torsional stresses. These stresses occur for example when an ATV straddles large objects or when the wheels of an ATV are disposed at different elevations. Frames designed to resist the momentarily intense forces described above do not necessarily result in frames that are sufficiently rigid in torsion to resist high levels of torsional stresses.

Also, the frame of an ATV is one of the heaviest components that make up the ATV. One way to reduce the weight of the frame is to use lighter components, such as aluminium. However, these lighter components tend to be less resistant to forces and stresses than the materials conventionally used in the manufacture of ATV frames, such as steel. Therefore, merely substituting the material of a conventional frame structure (box-type or beam-type frame) results in a frame that may not resist the forces and stresses associated with the riding conditions of ATVs. One solution consists in making a frame of lighter material having the conventional frame structure to which additional bracing is added. However, this additional bracing reduces the weight savings and also makes the manufacturing of the frame more difficult and labour intensive.

Therefore, there is a need for a frame for an ATV that is rigid in torsion.

There is also a need for an ATV frame structure that permits the use of materials that are lighter than the materials conventionally used in ATV frames.

### SUMMARY OF THE INVENTION

It is an object of the present invention to ameliorate at least some of the inconveniences present in the prior art.

It is also an object of the present invention to provide a frame for an ATV that is sufficiently rigid in torsion to be suitable to use under normal riding conditions.

It is also an object of the present invention to provide a frame structure that permits the use of lighter materials, such as aluminium, and that can be used in an ATV.

It is another object of the present invention to provide a frame for an ATV that includes a first pyramidally-shaped frame portion and a second pentahedrally-shaped frame portion. The first pyramidally-shaped frame portion has its apex pointing generally upwardly, while the second pentrahedrally-shaped frame portion has a vertex pointing generally downwardly.

It is yet another object of the present invention to provide an ATV including the frame described above.

By having a frame that includes a first pyramidally-shaped frame portion and a second pentrahedrally-shaped frame portion disposed as described above, any force applied to the frame generally causes one or more structural component of the frame, such as a member or a leg of the frame, to be in tension. This results in an improved rigidity of the frame in torsion. This construction also results in a better distribution of forces across the frame. Therefore lighter materials can be used in the construction of the frame.

In one aspect, the invention provides a frame for a vehicle has a first pyramidally-shaped frame portion and a second pentahedrally-shaped frame portion. The first frame portion has a first apex and a first base. The first apex is disposed vertically above the first base. The second frame portion has a first vertex and a second base. The first vertex is disposed vertically below the second base. The second frame portion is disposed vertically below the first frame portion. At least three wheel attachment portions are connected to the second pentahedrally-shaped frame portion. Each of the at least three wheel attachment portions is adapted to permit attachment of one of at least three wheels to be mounted to the frame.

In a further aspect, the first base and the second base are a single common base.

In an additional aspect, the second pentahedrally-shaped frame portion is a second pyramidally-shaped frame portion, and the first vertex is an apex of the second pyramidally-shaped frame portion.

In a further aspect, the second pentahedrally-shaped frame portion also includes a second vertex disposed vertically below the common base. The second vertex is disposed rearwardly of the first vertex.

In an additional aspect, the frame has a longitudinal centerline. The first apex, the first vertex, and the second vertex are disposed in a vertically extending plane passing through the longitudinal centerline. The first apex is disposed forwardly of the first vertex.

In a further aspect, the frame has a longitudinal centerline and the common base includes: a first base side member extending generally longitudinally and disposed on a first side of the longitudinal centerline, a second base side member extending generally longitudinally and disposed on a second side of the longitudinal centerline opposite the first side, a first base cross member extending generally transversely to the longitudinal centerline from the first base side member to the second base side member, the first base cross member being disposed forwardly of the first apex and the first vertex, and a second base cross member extending generally transversely to the longitudinal centerline from the first base side member to the second base side member, the second base cross member being disposed rearwardly of the first apex and the first vertex.

In an additional aspect, the first base side member and the second base side member are generally parallel to the longitudinal centerline.

In a further aspect, at least one of the first base side member and the second base side member is removably fastened to the frame by non-permanent fasteners.

In an additional aspect, the frame has a sub-frame extending rearwardly from at least one of the first pyramidally-shaped frame portion and the second pentahedrally-shaped portion. The sub-frame is adapted to receive a straddle-seat.

In a further aspect, the first pyramidally-shaped frame portion includes: a first leg extending from the first apex to a portion of the frame where the first base side member and the first base cross member meet, a second leg extending from the first apex to a portion of the frame where the second base side member and the first base cross member meet, a third leg extending from the first apex to a portion of the frame where the first base side member and the second base cross member meet, and a fourth leg extending from the first apex to a portion of the frame where the second base side member and the second base cross member meet.

In an additional aspect, the second pentahedrally-shaped frame portion includes: a fifth leg extending from the first vertex to a portion of the frame where the first base side member and the first base cross member meet, a sixth leg extending from the first vertex to a portion of the frame where the second base side member and the first base cross member meet, a seventh leg extending from the second vertex to a portion of the frame where the first base side member and the second base cross member meet, an eighth leg extending from the second vertex to a portion of the frame where the second base side member and the second base cross member meet, and a lower frame member extending from the first vertex to the second vertex.

In a further aspect, the frame has a first bracket connecting the first base side member, the first base cross member, the first leg, and the fifth leg together. The first bracket is adapted to connect a first shock absorber to the frame. The frame also has a second bracket connecting the second base side member, the first base cross member, the second leg, and the sixth leg together. The second bracket is adapted to connect a second shock absorber to the frame.

In an additional aspect, the frame has a lower frame portion disposed below the second pentahedrally-shaped frame portion along the longitudinal centerline. The first vertex and the second vertex are connected to the lower frame portion.

In a further aspect, the frame has a first foot peg connected to a first side of the lower frame portion, and a second foot peg connected to a second side of the lower frame portion opposite the first side.

In an additional aspect, at least two of the at least three wheel attachment portions are connected to the lower frame portion.

In a further aspect, the frame has a first steering column support adapted to receive a first portion of a steering column. The first steering column support is connected to the first pyramidally-shaped frame portion rearwardly of the first apex. The frame also has a second steering column support adapted to receive a second portion of a steering column. The second steering column support is connected to the lower frame portion forwardly of the first vertex and the common base.

In another aspect, the invention provides all-terrain vehicle having a frame. The frame has a first pyramidally-shaped frame portion and a second pentahedrally-shaped frame portion. The first frame portion has a first apex and a first base. The first apex is disposed vertically above the first base. The second frame portion has a first vertex and a second base. The first vertex is disposed vertically below the second base. The second frame portion is disposed vertically below the first frame portion. The frame also has at least three wheel attachment portions connected to the second pentahedrally-shaped frame portion. A straddle seat is mounted on the frame for supporting a driver. At least three wheels are suspended from the frame. Each of the at least three wheels is operatively attached to a corresponding one of the at least three wheel attachment portions. Each of the at least three wheels has a tire. A steering assembly is disposed forwardly of the straddle seat for steering at least one of the at least three wheels. An engine is mounted to the frame. At least a portion of the engine is disposed within the first base and extends through a plane defined by the first base.

In an additional aspect, the first base and the second base are a single common base.

In a further aspect, the second pentahedrally-shaped frame portion is a second pyramidally-shaped frame portion, and the first vertex is an apex of the second pyramidally-shaped frame portion.

In an additional aspect, the second pentahedrally-shaped frame also includes a second vertex disposed vertically below the common base. The second vertex is disposed rearwardly of the first vertex.

In a further aspect, the ATV has a longitudinal centerline. The first apex, the first vertex, and the second vertex are disposed in a vertically extending plane passing through the longitudinal centerline. The first apex is disposed forwardly of the first vertex.

In an additional aspect, the ATV has a longitudinal centerline, and the common base includes: a first base side member extending generally longitudinally and disposed on a first side of the longitudinal centerline, a second base side member extending generally longitudinally and disposed on a second side of the longitudinal centerline opposite the first side, a first base cross member extending generally transversely to the longitudinal centerline from the first base side member to the second base side member, the first base cross member being disposed forwardly of the first apex and the first vertex, and a second base cross member extending generally transversely to the longitudinal centerline from the first base side member to the second base side member, the second base cross member being disposed rearwardly of the first apex and the first vertex.

In a further aspect, the first base side member and the second base side member are generally parallel to the longitudinal centerline.

In an additional aspect, at least one of the first base side member and the second base side member is removably fastened to the frame by non-permanent fasteners to allow for removal of the engine from the frame.

In a further aspect, the frame also has a sub-frame extending rearwardly from at least one of the first and second pentahedrally-shaped frame portions. The straddle seat is mounted on the sub-frame.

In an additional aspect, the first pyramidally-shaped frame portion includes: a first leg extending from the first apex to a portion of the frame where the first base side member and the first base cross member meet, a second leg extending from the first apex to a portion of the frame where the second base side member and the first base cross member meet, a third leg extending from the first apex to a portion of the frame where the first base side member and the second base cross member meet, and a fourth leg extending from the first apex to a portion of the frame where the second base side member and the second base cross member meet.

In a further aspect, the second pentahedrally-shaped frame portion includes: a fifth leg extending from the first vertex to a portion of the frame where the first base side member and the first base cross member meet, a sixth leg extending from the first vertex to a portion of the frame where the second base side member and the first base cross member meet, a seventh leg extending from the second vertex to a portion of the frame where the first base side member and the second base cross member meet, an eighth leg extending from the second vertex to a portion of the frame where the second base side member and the second base cross member meet, and a lower frame member extending from the first vertex to the second vertex. A first portion of the engine extends from the first vertex to the third leg, and a second portion of the engine extends from the first vertex to the fourth leg.

In an additional aspect, the ATV has a first bracket connecting the first base side member, the first base cross member, the first leg, and the fifth leg together. A first shock absorber has a first end operatively connected to one of the at least three wheels and a second end connected to the first bracket. The ATV also has a second bracket connecting the second base side member, the first base cross member, the second leg, and the sixth leg together. A second shock absorber has a first end connected to another one of the at least three wheels and a second end connected to the second bracket.

In a further aspect, the frame also has a lower frame portion disposed below the second pentahedrally-shaped frame portion along the longitudinal centerline. The first vertex and the second vertex are connected to the lower frame portion. The engine is mounted on the lower frame portion.

In an additional aspect, the ATV has a first foot peg connected to a first side of the lower frame portion, and a second foot peg connected to a second side of the lower frame portion opposite the first side.

In a further aspect, at least two of the at least three wheel attachment portions are connected to the lower frame portion.

In an additional aspect, the steering assembly includes a steering column. The frame also has a first steering column support adapted to receive a first portion of the steering column. The first steering column support is connected to the first pyramidally-shaped frame portion rearwardly of the first apex. The frame also has a second steering column support adapted to receive a second portion of the steering column. The second steering column support is connected to the lower frame portion forwardly of the first vertex and the common base.

For purposes of this application, terms related to spatial orientation such as forwardly, rearwardly, left, and right, are as they would normally be understood by a driver of the vehicle sitting thereon in a normal riding position. Also, when referring to one element being vertically above or below another element, it should be understood that the element does not necessarily need to be directly above or below. The terms “vertically above” and “vertically below” generally only refer to the height of one element relative to another.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a perspective view from a front, left side of an ATV in accordance with the present invention;

FIG. 2 is a side view of a frame in accordance with the present invention having an engine of the ATV of FIG. 1 mounted thereto;

FIG. 3 is a perspective view from a front, left side of the frame of FIG. 2;

FIG. 4A is a schematic illustration of the frame of FIG. 3;

FIG. 4B is a schematic illustration of an alternative embodiment of a frame in accordance with the present invention;

FIG. 5 is a front view of the frame of FIG. 3 with front and rear suspensions of the ATV of FIG. 1 mounted thereto;

FIG. 6 is a left side view of the frame and suspensions of FIG. 5; and

FIG. 7 is a top view of the frame and suspensions of FIG. 5.

### DETAILED DESCRIPTION OF THE PREFERRED EMBODIMENTS

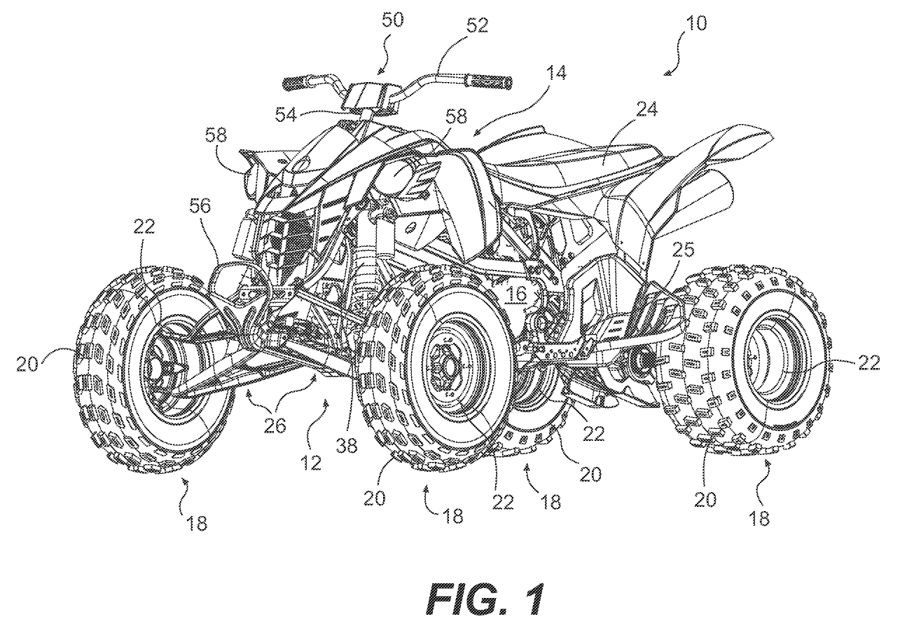

Turning now to FIG. 1, an ATV 10 includes a frame 12, described in more detail below, to which is mounted a body 14 and an internal combustion engine 16 for powering the vehicle. Also connected to the frame 12 are four wheels 18 with low-pressure balloon tires 20 mounted to rims 22 having a diameter from 25 to 36 cm. The low-pressure balloon tires 20 are inflated to a pressure of no more than 2 kg/cm² (i.e., no more than 196 kPa or 28 psi) and are adapted for off-road conditions and traversing rugged terrain. It is contemplated that other types of tires could be used, such as tires more suitable for road use. The ATV 10 further includes a straddle seat 24 mounted to the frame 12 for supporting a driver and optionally one or more passengers. A foot peg 25, preferably made of steel, is attached to each side of the frame 12 and extends therefrom to receive a foot of the driver of the ATV 20.

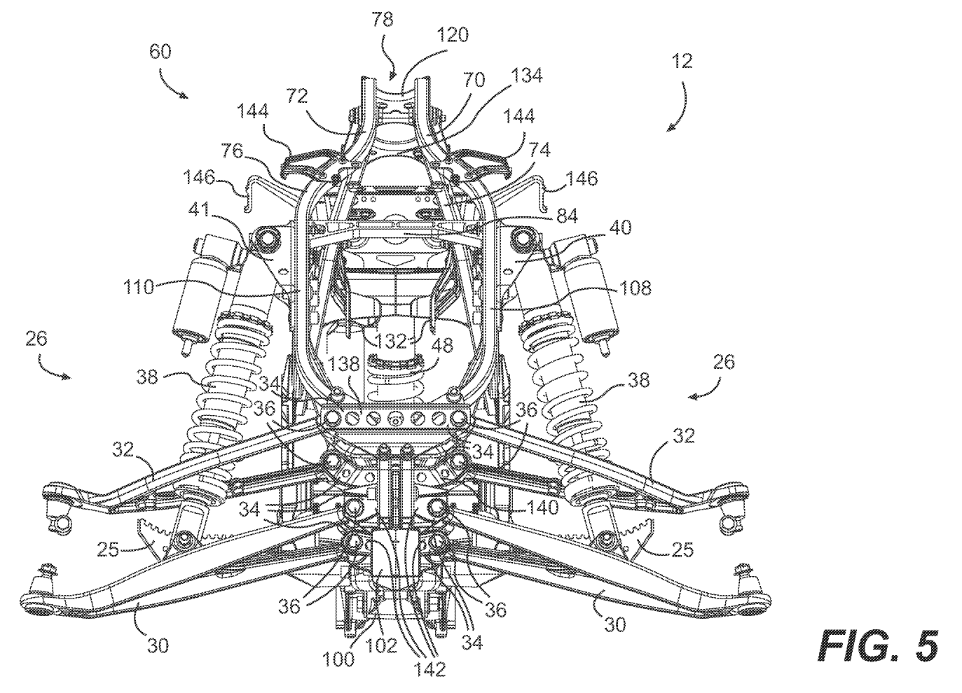

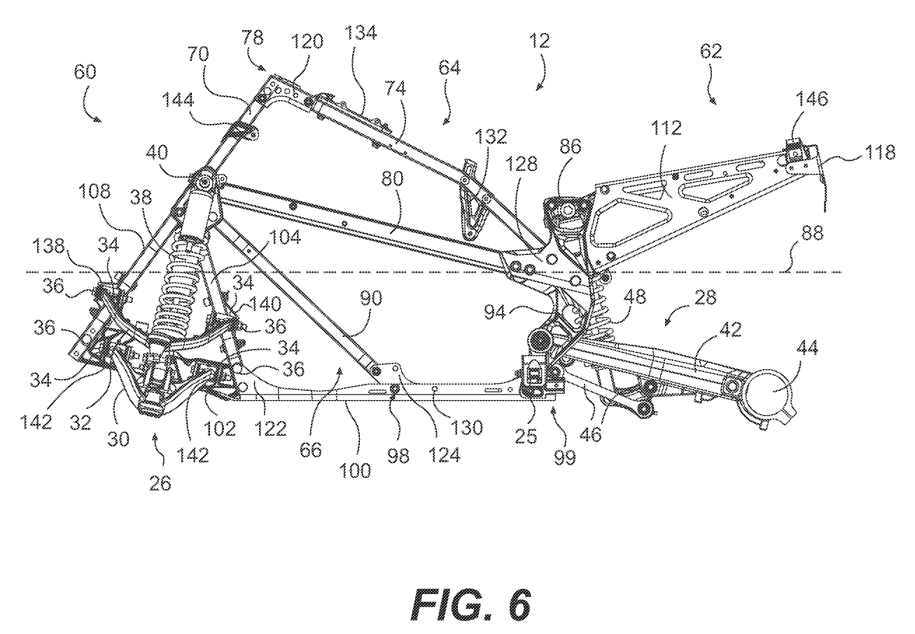

The two front wheels 18 are suspended from the frame 12 by respective front suspension assemblies 26 (FIG. 5), while the two rear wheels 18 are suspended from the frame 12 by a respective rear suspension assembly 28 (FIG. 6). As best seen in FIG. 5, each front suspension assembly 26 includes a lower A-arm 30 and an upper A-arm 32. The apexes of the lower and upper A-arms 30, 32 are operatively connected to their corresponding wheel 18 and the ends of the legs of the lower and upper A-arms 30, 32 are connected to wheel attachment portions 34 on the frame 12. In the embodiment shown, the wheel attachment portions 34 are in the form of brackets. A fastener 36 is used to connect the end of each leg of the A-arms 30, 32 to its corresponding bracket. The A-arms 30, 32 pivot about their corresponding fasteners 36. Each front suspension assembly 26 includes a shock absorber 38 that is connected at one end to the lower A-arm 30 and to a corresponding bracket 40 or 41 on the frame 12 at the other end. The rear suspension assembly 28 (FIG. 6) includes a swing arm 42 pivotally connected at one end to the frame 12. An opening 44 at the other end of the swing arm receives an axle (not shown) to which the rear wheels 18 are connected. Linkages 46 are connected between the swing arm 42 and the frame 12 to control the motion of the swing arm 42. A shock absorber 48 is connected at one end to one of the linkages 46 and to the frame 12 at the other end. It should be understood that the suspension assemblies 26, 28 described above are only exemplary and that other types and geometries of suspension assemblies could be used without deviating from the present invention.

Returning to FIG. 1, the ATV 10 further includes a steering assembly 50 which is rotationally supported by the frame 12, as described in greater detail below, to enable a driver to steer the vehicle. The steering assembly 50 includes a handlebar 52 connected to a steering column 54 for actuating steering linkages connected to the left and right front wheels 18. A throttle operator in the form of a thumb-actuated throttle lever (not shown) is mounted to the handlebar 52. Other types of throttle operators, such as a finger-actuated throttle lever and a twist grip, are also contemplated.

Other features of the ATV 10 include a handle 56 connected to a front portion of the frame 12 to facilitate the manual displacement of the ATV 10 in case it gets stuck, headlights 58 mounted to the body 14, a transmission (not shown) operatively connected between the engine 16 and the wheels 18 as is known in the art, and a shifter (not shown) located near the steering assembly 50 enables a driver to select one of a plurality of drive modes for the vehicle. The drive modes include park, neutral, reverse, low, and drive.

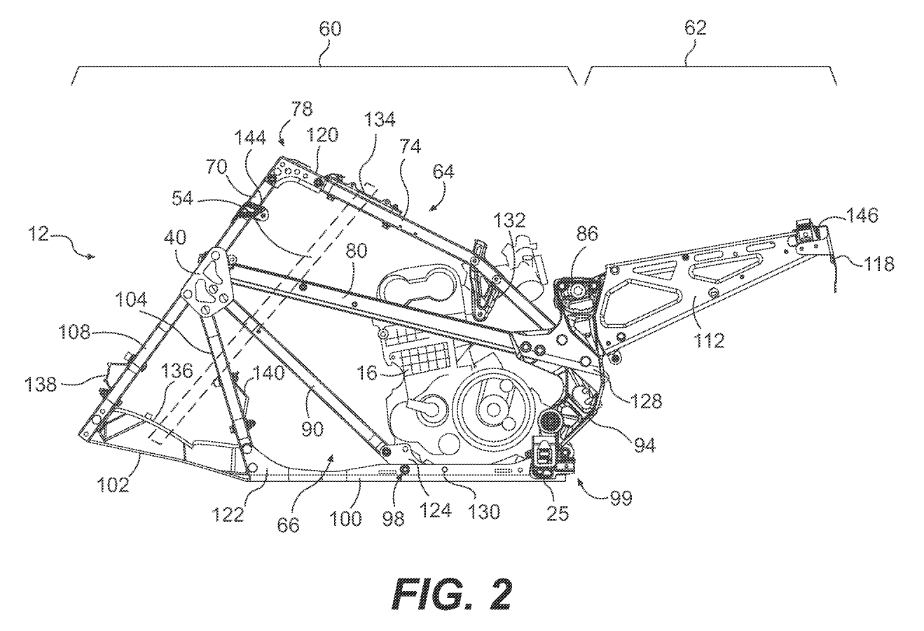

As seen in FIG. 2, the frame 12 is made of two portions connected to each other. These are the main frame 60 and the sub-frame 62 as indicated by their corresponding brackets. Note that for clarity, the main frame 60 and the sub-frame 62 are indicated by arrows rather than brackets in all the other Figures. The main frame 60 is the portion of the frame to which the wheels 18 are connected and therefore, it is constructed to resist the forces transmitted to the frame 12 via the wheels 18. The main frame 60 also receives the engine 16 and its components. The sub-frame 62 is connected to the main frame 60 and extends rearwardly from the main frame 60. The sub-frame 62 is adapted to receive the seat 24 thereon.

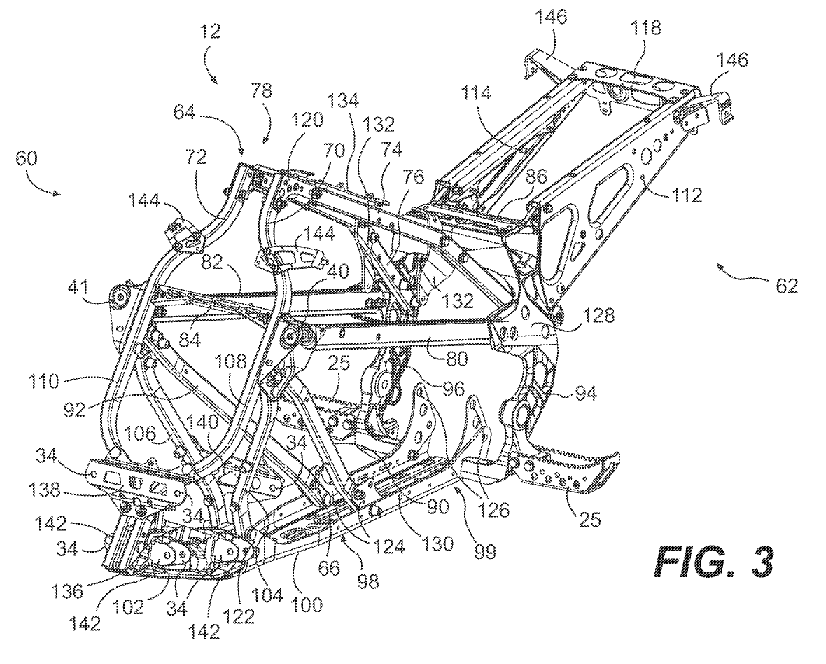

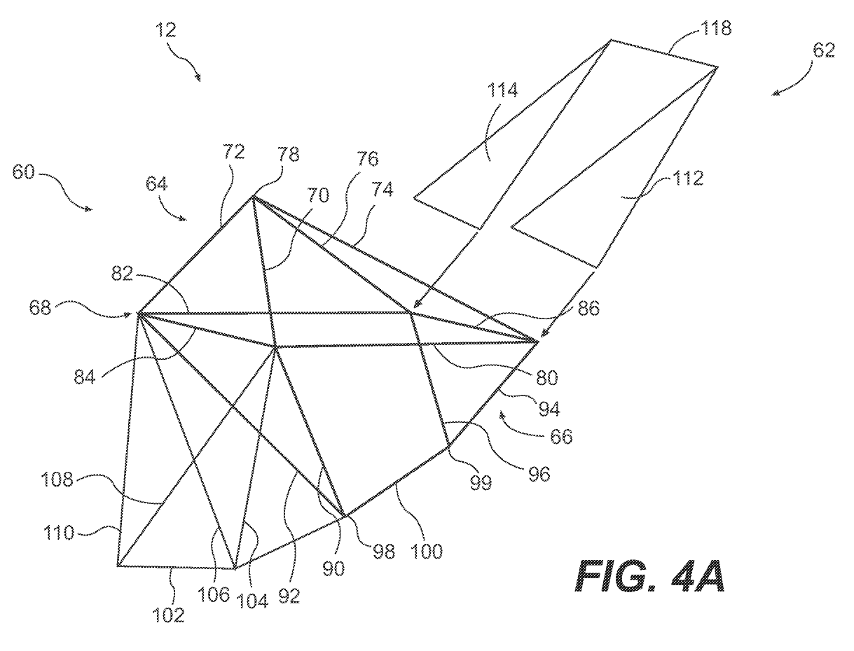

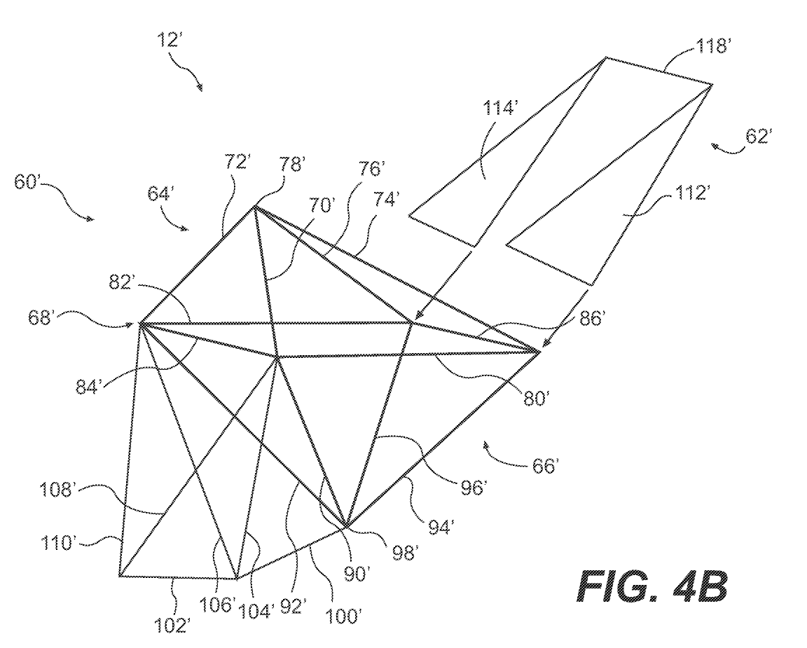

In order to facilitate an understanding of the construction of the frame 12, this construction will first be described with respect to the schematic representation of the frame 12 illustrated in FIG. 4A. The schematic representation of the frame 12 corresponds to a structurally equivalent representation of the frame 12 illustrated in FIG. 3.

As can be seen in FIG. 4A, the main frame portion 60 includes a first pyramidally-shaped frame portion 64 and a second pentahedrally-shaped frame portion 66. For clarity, the two frame portions 64, 66 are represented in FIG. 4A in a heavier line weight than the line weight used in the remainder of FIG. 4A.

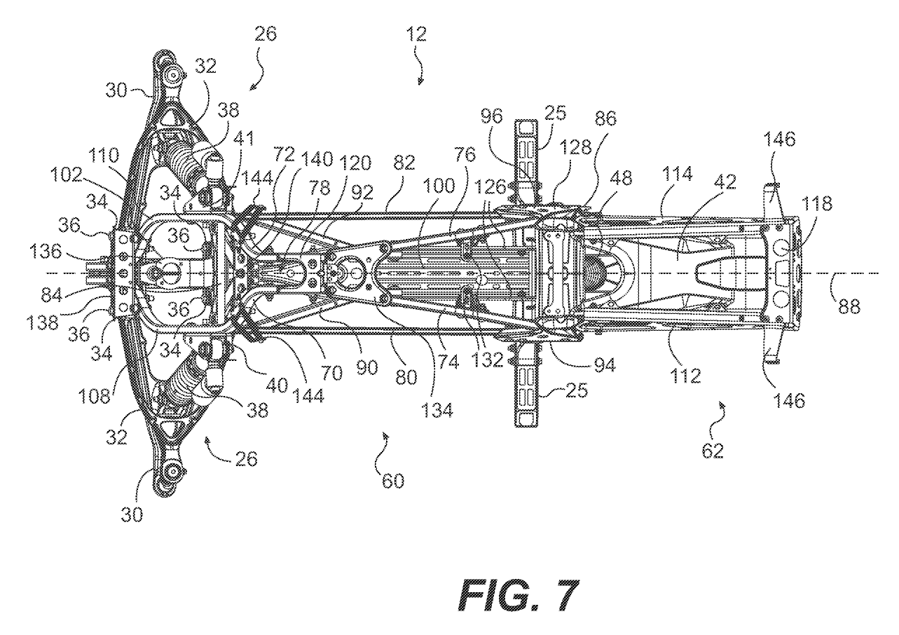

The first pyramidally-shaped frame portion 64 includes a base 68 and four legs 70, 72, 74, and 76 extending generally vertically downwardly from an apex 78 of the first pyramidally-shaped frame portion 64 to the base 68. The apex 78 is disposed along a longitudinal centerline 88 (FIGS. 6, 7) of the frame 12. It should be noted that, in a preferred embodiment, the longitudinal centerline 88 of the frame 12 corresponds with a longitudinal centerline (not shown) of the ATV 10. The base 68 includes first and second base side members 80 and 82 respectively and first and second base cross members 84 and 86 respectively. The base side members 80, 82 extend in a longitudinal direction of the frame 12 generally parallel to the longitudinal centerline 88, with the first base side member 80 being disposed to the left of the longitudinal centerline 88 and the second base side member 82 being disposed to the right of the longitudinal centerline 88. It is contemplated that the base side members 80, 82 could be disposed at an angle relative to the longitudinal centerline 88. The rear portions of the base side members 80, 82 are vertically lower than the forward portions thereof, such that the base side members 80, 82 extend at an angle relative to the horizontal. The first base cross member 84 extends generally transversely to the longitudinal centerline 88 from the first base side member 80 to the second base side member 82 at a position forwardly of the first apex 78. The second base cross member 86 extends generally transversely to the longitudinal centerline 88 from the first base side member 80 to the second base side member 82 at a position rearwardly of the first apex 78. The first leg 70 extends forwardly and downwardly from the apex 78 to the corner of the base 68 where the first base side member 80 and the first base cross member 84 meet. The second leg 72 extends forwardly and downwardly from the apex 78 to the corner of the base 68 where the second base side member 82 and the first base cross member 84 meet. The third leg 74 extends rearwardly and downwardly from the apex 78 to the corner of the base 68 where the first base side member 80 and the second base cross member 86 meet. The fourth leg 76 extends rearwardly and downwardly from the apex 78 to the corner of the base 68 where the second base side member 82 and the second base cross member 86 meet.

The second pentahedrally-shaped frame portion 66 includes the base 68, two legs 90 and 92 extending generally vertically upwardly from a first vertex 98 of the second pentahedrally-shaped frame portion 66 to the base 68, two legs 94 and 96 extending generally vertically upwardly from a second vertex 99 of the second pentahedrally-shaped frame portion 66 to the base 68, and a lower frame member 100 extending from the first vertex 98 to the second vertex 99. The vertices 98, 99 are disposed along the longitudinal centerline 88 rearwardly of the first base cross member 84 and forwardly of the second base cross member 86, with the second vertex 99 being disposed rearwardly of the first vertex 98. Also, as best seen in FIGS. 2 and 6, the apex 78 of the first pyramidally-shaped frame portion 64 is disposed forwardly of the first vertex 98 of the second pentahedrally-shaped frame portion 66. It is contemplated that the first and second frame portions 64, 66 could each have its own base instead of sharing a common base 68 as illustrated in the Figures. In such an embodiment, a base of the first pyramidally-shaped frame portion 64 would be disposed vertically above a base of the second pentahedrally-shaped frame portion 66 and the two bases would be linked to each other by additional legs, beams, or brackets. Returning to the embodiment illustrated in FIG. 4A, the fifth leg 90 extends forwardly and upwardly from the first vertex 98 to the corner of the base 68 where the first base side member 80 and the first base cross member 84 meet. The sixth leg 92 extends forwardly and upwardly from the first vertex 98 to the corner of the base 68 where the second base side member 82 and the first base cross member 84 meet. The seventh leg 94 extends rearwardly and upwardly from the second vertex 99 to the corner of the base 68 where the first base side member 80 and the second base cross member 86 meet. The eighth leg 96 extends rearwardly and upwardly from the second vertex 99 to the corner of the base 68 where the second base side member 82 and the second base cross member 86 meet.

By having first and second frame portion 64, 66 arranged as described above, the resulting frame 12 is rigid in torsion since, generally, regardless of the direction of a force applied to the frame 12 one or more of the legs 70, 72, 74, 76, 90, 92, 94, and 96 and the members 80, 82, 84, 86, and 100 of the main frame 60 will be in tension.

The main frame 60 also includes a lower frame portion made up of the lower frame member 100 and a suspension attachment 102. The lower frame member 100 is disposed generally horizontally along the longitudinal centerline 88. The first and second vertices 98, 99 of the second pentahedrally-shaped frame portion 66 are connected to the lower frame member 100. The suspension attachment 102 is also disposed along the longitudinal centerline 88. The suspension attachment 102 is connected to the front portion of the lower frame member 100 and extends forwardly and upwardly therefrom. As can also be seen in FIG. 4A, legs 104, 106, 108, and 110 extend from the suspension attachment 102 to the base 68. The legs 104, 106, 108, and 110 provide additional rigidity to the main frame 60 and provide attachment points to various components of the ATV 10, as described in more detail below. The ninth leg 104 extends from the forward end of the lower frame member 100 to the corner of the base 68 where the first base side member 80 and the first base cross member 84 meet. The tenth leg 106 extends from the forward end of the lower frame member 100 to the corner of the base 68 where the second base side member 82 and the first base cross member 84 meet. The eleventh leg 108 extends from the forward end of the suspension attachment 102 to the corner of the base 68 where the first base side member 80 and the first base cross member 84 meet. The twelfth leg 110 extends from the forward end of the suspension attachment 102 to the corner of the base 68 where the second base side member 82 and the first base cross member 84 meet.

As can be seen in FIG. 4A, the sub-frame 62 is generally wedge-shaped. The sub-frame 62 includes two triangular side portions 112 and 114. The forward portions of the triangular side portions 112, 114 are connected to the main frame 60. More specifically, the front lower portions of the triangular side portions 112, 114 are connected to corresponding rear corners of the base 68 of the main frame 60. The rearward portions of the triangular side portions 112, 114 are connected to each other by a rear sub-frame cross member 118.

Turning now to FIGS. 2, 3, and 5 to 7, specific aspects of the actual frame 12 and differences between the actual frame 12 and the structurally equivalent one illustrated in FIG. 4 will now be described. It should be understood that although the vertices and apexes in the actual frame 12 do not necessarily terminate in a point as in the frame 12 shown in FIG. 4A, that they are nonetheless considered as such (i.e. even though the ends of some elements may be slightly space apart, they are nonetheless considered as an apex or vertex, as the case may be, as per the structurally equivalent frame 12 shown in FIG. 4A).

As seen in FIG. 3, the first leg 70 and the eleventh leg 108 are integrally formed. Similarly, the second leg 72 and the twelfth leg 110 are integrally formed. The lower ends of the eleventh and twelfth legs 108, 110 are fastened to the forward end of the suspension attachment 102. A bracket 120 (best seen in FIGS. 3 and 7) is used to connect the upper ends of the first leg 70, the second leg 72, the third leg 74 and the fourth leg 78 together. The legs 70, 72, 74, and 78 are fastened to the bracket 120. The lower ends of the ninth and tenth legs 104, 106 are fastened to tabs 122 extending from the lower frame member 100 with the rear end of the suspension attachment 102 disposed between the lower ends of the legs 104, 106. The lower ends of the fifth and sixth legs are fastened to tabs 124 extending from a central portion of the lower member 100. The lower member 100 extends rearwardly from tabs 124 and has tabs 126 extending from a rear portion thereof to permit attachment of the engine 16 to the frame 12 as described in greater detail below.

The bracket 40 is used to connect together, via fasteners, the lower end of the first leg 70, the left end of the first base cross member 84, the front end of the of the first base side member 80, and the upper ends of the fifth, ninth, and eleventh legs 90, 104, 108. Similarly, the bracket 41 is used to connect together, via fasteners, the lower end of the second leg 72, the right end of the first base cross member 84, the front end of the of the second base side member 82, and the upper ends of the sixth, tenth, and twelfth legs 92, 106, 110. As previously mentioned, the upper end of each of the shock absorbers 38 is also connected to a corresponding one of the brackets 40, 41 as best seen in FIG. 5.

The legs 70, 72, 74, 76, 90, 92, 94, 96, 104, 106, 108, and 110, and the members 80, 82, 84, 86, and 100 are preferably made of aluminium. The brackets 40, 41, and 120 are preferably made of steel. The suspension attachment 102 is preferably made of forged aluminium.

The rear portion of the main frame 60 includes an inverted U-shaped brace 128 that integrally forms the second base cross member 86, the seventh leg 94, and the eighth leg 96. The lower ends of the seventh and eighth legs 94, 96 are fastened to the rear portion of the lower frame member 100. The foot pegs 25 are connected to the lower frame member 100 via the seventh and eighth legs 94, 96 to which they are fastened. The lower end of the third leg 74 and the rear end of the first base side member 80 are fastened to the left side of the brace 128. Similarly, the lower end of the fourth leg 76 and the rear end of the second base side member 82 are fastened to the right side of the brace 128. The upper end of shock absorber 48 is connected to the second base cross member 86. The sub-frame 62 is connected to the main frame 60 by the brace 128. The brace 128 is preferably an aluminium casting.

The left and right triangular sides 112, 114 of the sub-frame 62 are fastened at a front thereof to the brace 128. The rear sub-frame cross member 118 is fastened to the rear of the left and right triangular sides 112, 114. The left and right triangular sides 112, 114 and the rear sub-frame cross member 118 are made of bent sheet metal, preferably aluminium.

As can be seen in FIG. 2, the engine 16 sits between the first and second vertices 98, 99 on the lower frame member 100. The lower portion of the engine 16 (i.e. the crankcase) is rigidly mounted to the tabs 124, the tabs 126 and to apertures 130 on the lower frame member 100 that are longitudinally intermediate the tabs 124 and 126. The upper portion of the engine 16 (i.e. the cylinder head) is rigidly mounted to the third and fourth legs 74, 76 via brackets 132. By mounting the engine 16 in this manner, the engine 16 provides additional structural rigidity to the frame 12.

As can also be seen in FIG. 2, the upper portion of the engine 16 is disposed within the base 68 and extends through a plane defined by the base 68 (i.e. a plane passing through member 80, 82, 84, and 86). Therefore, in order to facilitate the installation and removal of the engine 16 in the frame 12, at least one, and preferably both, of the first and second base side members 80, 82 is removably fastened to the rest of the frame 12 by non-permanent fasteners, such as bolts.

As best seen in FIG. 7, first and second steering column supports 134, 136 each having an aperture therein, are provided on the main frame 60. The steering column 54 is disposed in the apertures so as to be supported by the steering column supports 134, 136 and can rotate therein. The first steering column support 134 receives an upper portion of the steering column 54 and the second steering column support 136 receives a lower portion of the steering column 54. The first steering column support 134 is fastened to the third and fourth legs 74, 78 rearwardly of the bracket 120. The second steering column support 136 is integrally formed with the suspension attachment 102 and forms an upper portion thereof such that the aperture of the second steering column support 136 is disposed forwardly of the first base cross member 84.

As best seen in FIG. 3, six A-arm attachment brackets 138, 140, and 142, providing the wheel attachment portions, 34 are connected to the forward portion of the main frame 60. The upper A-arms 32 are fastened between the A-arm attachment brackets 138, 140. The lower A-arms 30 are fastened to the four A-arm attachment brackets 142 (two brackets 142 per A-arm 30). The A-arm attachment bracket 138 is fastened to the front side of the eleventh and twelfth legs 108, 110. The A-arm attachment bracket 140 is fastened to the back side of the ninth and tenth legs 104, 106. The four A-arm attachment brackets 142 are fastened to either side of the suspension attachment 102, with two of the brackets 142 on a front portion of the suspension attachment 102 and two of the brackets 142 on a rear portion of the suspension attachment 102. The brackets 138 and 140 are preferably made of aluminium, and the brackets 142 are preferably made of steel.

Front and rear body mounting brackets 144 and 146 are connected to the frame 12 to permit the mounting of the body 14 to the frame 12. One of the front body mounting brackets 144 is fastened to the first leg 70, while the other of the front body mounting brackets 144 is fastened to the second leg 72. One of the rear body mounting brackets 146 is fastened to the left triangular side 112 of the sub-frame 62, while the other of the rear body mounting brackets 146 is fastened to the right triangular side 114 of the sub-frame 62. The front and rear body mounting brackets 144 and 146 are preferably made of aluminium.

As mentioned above, the various components of the frame 12 are fastened together. Preferably, the fasteners used are bolts or rivets. It is contemplated that other types of fasteners could be used. It is also contemplated that components of the frame 12 could be welded or integrally formed together.

Turning now to FIG. 4B, an alternative embodiment of a frame 12′ that can be used in the ATV 10 is illustrated schematically. Note that for simplicity, elements in frame 12′ which are similar to those in frame 12 have been labelled with the same reference numeral with the addition of a prime (for example leg 72 is now 72′).

Like frame 12, frame 12′ is made of two portions connected to each other. These are the main frame 60′ and the sub-frame 62′. As can be seen in FIG. 4B, the main frame portion 60′ includes a first pyramidally-shaped frame portion 64′ and a second pyramidally-shaped frame portion 66′. For clarity, the two frame portions 64′, 66′ are represented in FIG. 4B in a heavier line weight than the line weight used in the remainder of FIG. 4B.

Of all the portions of the frame 12′, only the second pyramidally-shaped frame portion 66′ is significantly different of its corresponding portion in frame 12, and as such only this portion will be described herein in detail. The second pyramidally-shaped frame portion 66′ includes base 68′ and four legs 90′, 92′, 94′, and 96′ extending generally vertically upwardly from an apex 98′ of the second pyramidally-shaped frame portion 66′ to the base 68′. The apex 98′ is disposed along the longitudinal centerline of the frame 12′ rearwardly of the first base cross member 84′ and forwardly of the second base cross member 86′. Also, the apex 78′ of the first pyramidally-shaped frame portion 64′ is disposed forwardly of the apex 98′ of the second pyramidally-shaped frame portion 66′. The fifth leg 90′ extends forwardly and upwardly from the apex 98′ to the corner of the base 68′ where the first base side member 80′ and the first base cross member 84′ meet. The sixth leg 92′ extends forwardly and upwardly from the apex 98′ to the corner of the base 68′ where the second base side member 82′ and the first base cross member 84′ meet. The seventh leg 94′ extends rearwardly and upwardly from the apex 98′ to the corner of the base 68′ where the first base side member 80′ and the second base cross member 86′ meet. The eighth leg 96′ extends rearwardly and upwardly from the apex 98′ to the corner of the base 68′ where the second base side member 82′ and the second base cross member 86′ meet. In an actual frame 12′ the seventh and eighth legs 94′, 96′ would have a structure similar to that of legs 90 and 92 of frame 12 and would preferably be made of aluminium.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A frame for a vehicle comprising:
a first pyramidally-shaped frame portion, the first frame portion having a first apex and a first base, the first apex being disposed vertically above the first base;
a second pentahedrally-shaped frame portion, the second frame portion having a first vertex and a second base, the first vertex being disposed vertically below the second base, the second frame portion being disposed vertically below the first frame portion; and
at least three wheel attachment portions connected to the second pentahedrally-shaped frame portion, each of the at least three wheel attachment portions being adapted to permit attachment of one of at least three wheels to be mounted to the frame.

2. The frame of claim 1, wherein the first base and the second base are a single common base.

3. The frame of claim 2, wherein the second pentahedrally-shaped frame portion is a second pyramidally-shaped frame portion; and
wherein the first vertex is an apex of the second pyramidally-shaped frame portion.

4. The frame of claim 2, wherein the second pentahedrally-shaped frame portion further includes a second vertex disposed vertically below the common base, the second vertex being disposed rearwardly of the first vertex.

5. The frame of claim 4, further comprising a longitudinal centerline;
wherein the first apex, the first vertex, and the second vertex are disposed in a vertically extending plane passing through the longitudinal centerline; and
wherein the first apex is disposed forwardly of the first vertex.

6. The frame of claim 4, further comprising a longitudinal centerline; and
wherein the common base includes:
a first base side member extending generally longitudinally and disposed on a first side of the longitudinal centerline;
a second base side member extending generally longitudinally and disposed on a second side of the longitudinal centerline opposite the first side;
a first base cross member extending generally transversely to the longitudinal centerline from the first base side member to the second base side member, the first base cross member being disposed forwardly of the first apex and the first vertex; and
a second base cross member extending generally transversely to the longitudinal centerline from the first base side member to the second base side member, the second base cross member being disposed rearwardly of the first apex and the first vertex.

7. The frame of claim 6, wherein the first base side member and the second base side member are generally parallel to the longitudinal centerline.

8. The frame of claim 6, wherein at least one of the first base side member and the second base side member is removably fastened to the frame by non-permanent fasteners.

9. The frame of claim 6, further comprising a sub-frame extending rearwardly from at least one of the first pyramidally-shaped frame portion and the second pentahedrally-shaped portion, the sub-frame being adapted to receive a straddle-seat.

10. The frame of claim 6, wherein the first pyramidally-shaped frame portion includes:
a first leg extending from the first apex to a portion of the frame where the first base side member and the first base cross member meet;
a second leg extending from the first apex to a portion of the frame where the second base side member and the first base cross member meet;
a third leg extending from the first apex to a portion of the frame where the first base side member and the second base cross member meet; and
a fourth leg extending from the first apex to a portion of the frame where the second base side member and the second base cross member meet.

11. The frame of claim 10, wherein the second pentahedrally-shaped frame portion includes:
a fifth leg extending from the first vertex to a portion of the frame where the first base side member and the first base cross member meet;
a sixth leg extending from the first vertex to a portion of the frame where the second base side member and the first base cross member meet;
a seventh leg extending from the second vertex to a portion of the frame where the first base side member and the second base cross member meet;
an eighth leg extending from the second vertex to a portion of the frame where the second base side member and the second base cross member meet; and
a lower frame member extending from the first vertex to the second vertex.

12. The frame of claim 11, further comprising:
a first bracket connecting the first base side member, the first base cross member, the first leg, and the fifth leg together, the first bracket being adapted to connect a first shock absorber to the frame; and
a second bracket connecting the second base side member, the first base cross member, the second leg, and the sixth leg together, the second bracket being adapted to connect a second shock absorber to the frame.

13. The frame of claim 5, further comprising a lower frame portion disposed below the second pentahedrally-shaped frame portion along the longitudinal centerline; and
wherein the first vertex and the second vertex are connected to the lower frame portion.

14. The frame of claim 13, further comprising:
a first foot peg connected to a first side of the lower frame portion; and
a second foot peg connected to a second side of the lower frame portion opposite the first side.

15. The frame of claim 13, wherein at least two of the at least three wheel attachment portions are connected to the lower frame portion.

16. The frame of claim 13, further comprising:
a first steering column support adapted to receive a first portion of a steering column, the first steering column support being connected to the first pyramidally-shaped frame portion rearwardly of the first apex; and
a second steering column support adapted to receive a second portion of a steering column, the second steering column support being connected to the lower frame portion forwardly of the first vertex and the common base.

17. An all-terrain vehicle comprising:
a frame, the frame including:
a first pyramidally-shaped frame portion, the first frame portion having a first apex and a first base, the first apex being disposed vertically above the first base;
a second pentahedrally-shaped frame portion, the second frame portion having a first vertex and a second base, the first vertex being disposed vertically below the second base, the second frame portion being disposed vertically below the first frame portion; and
at least three wheel attachment portions connected to the second pentahedrally-shaped frame portion;
a straddle seat mounted on the frame for supporting a driver;
at least three wheels suspended from the frame, each of the at least three wheels being operatively attached to a corresponding one of the at least three wheel attachment portions, each of the at least three wheels having a tire;
a steering assembly disposed forwardly of the straddle seat for steering at least one of the at least three wheels; and
an engine mounted to the frame, at least a portion of the engine being disposed within the first base and extending through a plane defined by the first base.

18. The vehicle of claim 17, wherein the first base and the second base are a single common base.

19. The vehicle of claim 18, wherein the second pentahedrally-shaped frame portion is a second pyramidally-shaped frame portion; and
wherein the first vertex is an apex of the second pyramidally-shaped frame portion.

20. The vehicle of claim 18, wherein the second pentahedrally-shaped frame further includes a second vertex disposed vertically below the common base, the second vertex being disposed rearwardly of the first vertex.

21. The vehicle of claim 20, further comprising a longitudinal centerline;
wherein the first apex, the first vertex, and the second vertex are disposed in a vertically extending plane passing through the longitudinal centerline; and
wherein the first apex is disposed forwardly of the first vertex.

22. The vehicle of claim 20, further comprising a longitudinal centerline; and
wherein the common base includes:
a first base side member extending generally longitudinally and disposed on a first side of the longitudinal centerline;
a second base side member extending generally longitudinally and disposed on a second side of the longitudinal centerline opposite the first side;
a first base cross member extending generally transversely to the longitudinal centerline from the first base side member to the second base side member, the first base cross member being disposed forwardly of the first apex and the first vertex; and
a second base cross member extending generally transversely to the longitudinal centerline from the first base side member to the second base side member, the second base cross member being disposed rearwardly of the first apex and the first vertex.

23. The vehicle of claim 22, wherein the first base side member and the second base side member are generally parallel to the longitudinal centerline.

24. The vehicle of claim 22, wherein at least one of the first base side member and the second base side member is removably fastened to the frame by non-permanent fasteners to allow for removal of the engine from the frame.

25. The vehicle of claim 22, wherein the frame further includes a sub-frame extending rearwardly from at least one of the first and second pentahedrally-shaped frame portions; and
wherein the straddle seat is mounted on the sub-frame.

26. The vehicle of claim 22, wherein the first pyramidally-shaped frame portion includes:
a first leg extending from the first apex to a portion of the frame where the first base side member and the first base cross member meet;
a second leg extending from the first apex to a portion of the frame where the second base side member and the first base cross member meet;
a third leg extending from the first apex to a portion of the frame where the first base side member and the second base cross member meet; and
a fourth leg extending from the first apex to a portion of the frame where the second base side member and the second base cross member meet.

27. The vehicle of claim 26, wherein the second pentahedrally-shaped frame portion includes:
a fifth leg extending from the first vertex to a portion of the frame where the first base side member and the first base cross member meet;
a sixth leg extending from the first vertex to a portion of the frame where the second base side member and the first base cross member meet;
a seventh leg extending from the second vertex to a portion of the frame where the first base side member and the second base cross member meet;
an eighth leg extending from the second vertex to a portion of the frame where the second base side member and the second base cross member meet; and
a lower frame member extending from the first vertex to the second vertex; and
wherein a first portion of the engine extends from the first vertex to the third leg, and a second portion of the engine extends from the first vertex to the fourth leg.

28. The vehicle of claim 27, further comprising:
a first bracket connecting the first base side member, the first base cross member, the first leg, and the fifth leg together;
a first shock absorber having a first end operatively connected to one of the at least three wheels and a second end connected to the first bracket;
a second bracket connecting the second base side member, the first base cross member, the second leg, and the sixth leg together; and
a second shock absorber having a first end connected to another one of the at least three wheels and a second end connected to the second bracket.

29. The vehicle of claim 21, wherein the frame further includes a lower frame portion disposed below the second pentahedrally-shaped frame portion along the longitudinal centerline;
wherein the first vertex and the second vertex are connected to the lower frame portion; and
wherein the engine is mounted on the lower frame portion.

30. The vehicle of claim 29, further comprising:
a first foot peg connected to a first side of the lower frame portion; and
a second foot peg connected to a second side of the lower frame portion opposite the first side.

31. The vehicle of claim 29, wherein at least two of the at least three wheel attachment portions are connected to the lower frame portion.

32. The vehicle of claim 29, wherein the steering assembly includes a steering column; and
wherein the frame further includes:
a first steering column support adapted to receive a first portion of the steering column, the first steering column support being connected to the first pyramidally-shaped frame portion rearwardly of the first apex; and
a second steering column support adapted to receive a second portion of the steering column, the second steering column support being connected to the lower frame portion forwardly of the first vertex and the common base.
